(19) United States
(12) Patent Application Publication
(10) Pub. No.: US 2021/0100640 A1
(43) Pub. Date: Apr. 8, 2021

(54) PROSTHESIS SUBASSEMBLY

(71) Applicant: Alan F. Robinson, Clinton Twp., MI (US)

(72) Inventor: Alan F. Robinson, Clinton Twp., MI (US)

(21) Appl. No.: 17/064,757

(22) Filed: Oct. 7, 2020

Related U.S. Application Data
(60) Provisional application No. 62/911,423, filed on Oct. 7, 2019.

(51) Int. Cl. A61C 8/00

(52) U.S. Cl. CPC A61C 8/0051; A61C 8/0053

(57) ABSTRACT

A dental prothesis subsurface assembly including an O-ball joint distal from a neck, the neck having a smaller diameter than the O-ball and extending from an implant or an abutment, and a polymeric sleeve having a first inner diameter portion and a different second inner diameter portion the second inner diameter portion or the first inner diameter portion adapted to overlie the neck and the O-ball joint and having a portion of the O-ball joint extending into the other portion, the other portion adapted to receive a socket of a prothesis to prevent direct contact between the O-ball joint and the socket. Additionally, a process of joining a prosthesis to an implant including placing a polymeric sleeve over the O-ball joint and the neck of the implant and inserting a socket of the prosthesis over the sleeve joining the prosthesis and the implant without direct contact therebetween.

### CROSS-REFERENCE TO RELATED APPLICATION

This application claims priority of U.S. Provisional Patent Application Ser. No. 62/911,423 filed Oct. 7, 2019, which is incorporated herein by reference.

### FIELD OF THE INVENTION

The present invention in general relates to dental implant technology; and in particular, to an endosteal or subperiosteal dental implant with a superior wearing coupling to a prosthesis.

### BACKGROUND OF THE INVENTION

Dental implants are replacement tooth roots. Implants provide a strong foundation for fixed (permanent) or removable replacement teeth that are made to match natural teeth. As shown in prior art FIG. 1 an implant 10, which are generally in the shape of a threaded screw, is inserted into the patient bone 12. Implants are made of materials, such as titanium, that encourage osseointegration with patient bone to form a secure and stable connection. A connector called an abutment 14 is often placed on or engaged with top of the dental implant to hold and support a dental prosthesis such as a crown 16 which may be a single tooth or a bridge with multiple teeth. A series of implants and abutments may be used to provide in a subject to provide a set of connection points for a large dental prosthesis.

Problems associated with existing implants include: insufficient retention of metal-to-metal contact associated with o-ball connection between an implant and an attached prosthesis, elevated connection point relative to the anchoring bone, insufficient retention, and an insufficient implant platform surface to anchor an attachment to an abutment. These problems collectively lead to patient discomfort and reduced prosthesis function and/or retention that may lead to prosthesis breakage and failure, which leads to reduced operational lifetime of prosthesis, and/or injury to a patient.

While there have been many improvements in dental prosthetics and implant technologies, there continues to be a need for improvements that address the aforementioned problems so as to extend the longevity and improve function of a prosthesis.

### SUMMARY OF THE INVENTION

The present invention provides a dental prothesis subsurface assembly that includes an O-ball joint portion having a diameter, the O-ball joint portion distal from a neck portion, the neck portion having a smaller diameter than the O-ball portion and extending from an implant or an abutment, and a polymeric sleeve having a first inner diameter portion having a first inner diameter and a second inner diameter portion having a second inner diameter, the second inner diameter being a different than the first inner diameter; the second inner diameter portion or the first inner diameter portion adapted to overlie the neck portion and the O-ball joint portion and having a portion of the O-ball joint portion extending into the other portion, the other portion adapted to receive a socket of a prothesis to prevent direct contact between the O-ball joint portion and the socket.

The present invention additionally provides a kit that includes a plurality of a mini-implants, abutments, or a combination thereof, each having an O-ball joint portion distal from a neck portion, the neck portion extending from an attachment portion that is joined to a platform having a larger diameter than the neck portion, the platform terminating in a base having a height, each of the plurality of the mini-implants, the abutments, or the combination thereof varying in the height; and at least one polymeric sleeve having a first inner diameter portion having a first inner diameter and a second inner diameter portion having a second inner diameter, the second inner diameter being a different than the first inner diameter; the second inner diameter portion or the first inner diameter portion adapted to overlie the neck portion and the O-ball joint portion and having a portion of the O-ball joint portion extending into the other portion, the other portion adapted to receive a socket of a prothesis to prevent contact between the O-ball joint portion and the socket.

A process of joining a prosthesis to an implant is additionally provided. The procession includes securing the implant to tissue of a patient, the implant terminating in an O-ball joint portion distal extending from a neck portion, placing a polymeric sleeve over the O-ball joint portion and the neck portion, and inserting a socket of the prosthesis over the polymeric sleeve to join the prosthesis and the implant without direct contact therebetween after an O-ring is installed in the resulting cavity.

The present invention also provides an abutment that includes an O-ball joint portion distal from a neck portion, the neck portion extending from an attachment portion having a larger diameter than the neck portion, the attachment portion extending from a platform having a diameter of from 4 to 6 mm and a base having a height, and a taper portion joined to the base.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a prior art installation of a dental implant, abutment, and crown;

FIGS. 2A-2C illustrate a series of views of a removable flexible plastic cavity mold to create a spherical ball retainer cavity for a prosthesis to have a metal-free ball attachment in accordance with embodiments of the invention in side view (FIG. 2A), partially transparent top view (FIG. 2B), and partially transparent perspective view (FIG. 2C);

FIGS. 3A and 3B illustrate a spacer in top view (FIG. 3A) and side view (FIG. 3B) used to adapt an existing dental micro-implant to a sub-surface attachment in accordance with embodiments of the invention;

FIGS. 4A-4C illustrate a series of views of an inventive abutment with a distal O-ball attachment in top view (FIG. 4A), partially transparent perspective view (FIG. 4B), and partially transparent side view (FIG. 4C);

FIG. 5 illustrates in partial transparency an implant with a removable flexible plastic cavity mold placed over an O-ball attachment in accordance with an embodiments of the invention; and

FIGS. 6A-6D illustrate a range of heights of an inventive device of varying heights of attachment portions of 4 mm (FIG. 6A), 3 mm (FIG. 6B), 2 mm (FIG. 6C), and 1 mm (FIG. 6D).

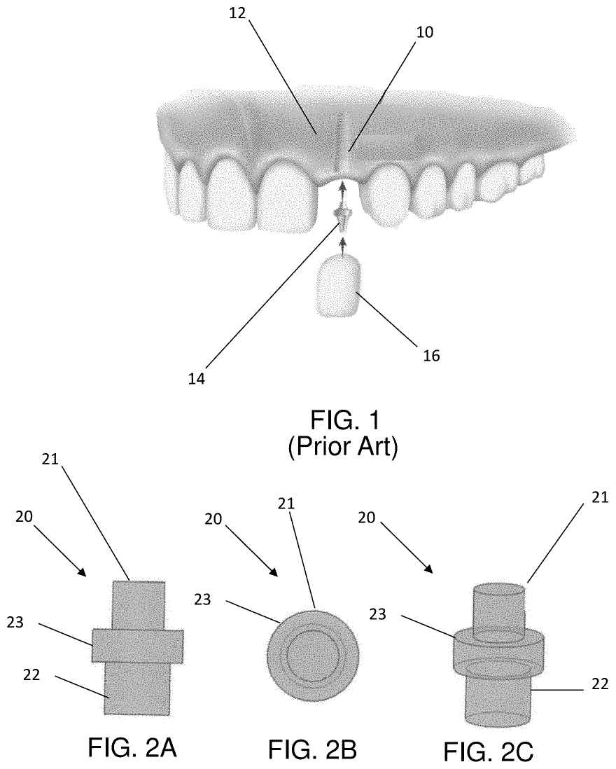

### DESCRIPTION OF THE INVENTION

The present invention has utility as a sub-surface attachment (SSA) that may be used with conventional implants, as well as, with modified inventive implants devices to anchor oral and other prostheses, such as an ear prothesis. Embodiments of the inventive sub-surface attachment provide a lower profile than presently available prior art abutment attachments. The sub-surface position of the inventive SSA reduces rocking and lateral wear forces on the anchoring implant and subsequently provides greater stability of the prosthesis being attached. The lower profile of the inventive SSA allows for addition to existing contour of the prosthesis to afford strengthened designs thereof relative to existing structures presently in use. In addition, an inventive SSA has a pronounced platform that is between 1.5 and 2.5 in radius relative to a distal O-ball extending from the platform. In typical embodiments of the present invention adapted for the mouth of an adult human, the platform diameter is between 4.5 and 6 millimeters (mm), in contrast to conventional implants with comparable diameters of 2 to 3 mm.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment can be deleted from that embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations and variations thereof.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

All publications, patent applications, patents, and other references mentioned herein are incorporated by reference in their entirety.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also, as used herein, “and/or” refers to and encompasses any and all possible combinations of one or more of the associated listed items, as well as the lack of combinations when interpreted in the alternative (“or”).

As used herein, the term “implant” refers to a medical device that interfaces with patient bone to support a dental prosthesis; such as a bridge, crown, denture; a facial prosthesis, such as brow or jaw prosthesis; or an aural prothesis. Implants are appreciated to either be endosteal or eposteal in nature.

As used herein, the term “abutment” refers to a connector or assembly of connector components integral with or attached to an implant and also adapted to receive a prosthesis.

As used herein, the term “tool contacting” refers to the portion of an abutment adapted to engage a tool used to selectively secure the abutment to other components of a prosthesis and in particular to an implant.

As used herein, the term “molecular weight” with respect to a polymer refers to number average molecular weight, Mn.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

While the present invention is illustrated visually hereafter with respect to a human jaw as the bone for which embodiments of the invention are installed and to which the present invention is applied, it is appreciated that the present invention is equally applicable to other bones of a human, non-human primate, or other mammals.

Embodiments of the invention provide an abutment, spacer modifier, and a sleeve for metal-free attachment of a prosthetic. Prosthetics illustratively include crowns, bridges, and dentures. Conventional implants may be placed in existing bone or sinus cavity utilizing sinus bump or lateral sinus grafts to create bone for attachment when or where none exists. Materials for prosthesis may include zirconium, acrylic, polyether ethyl ketone (PEEK), composite resin, nylon, thermoplastic, silicate, porcelain, ceramics, and other metals.

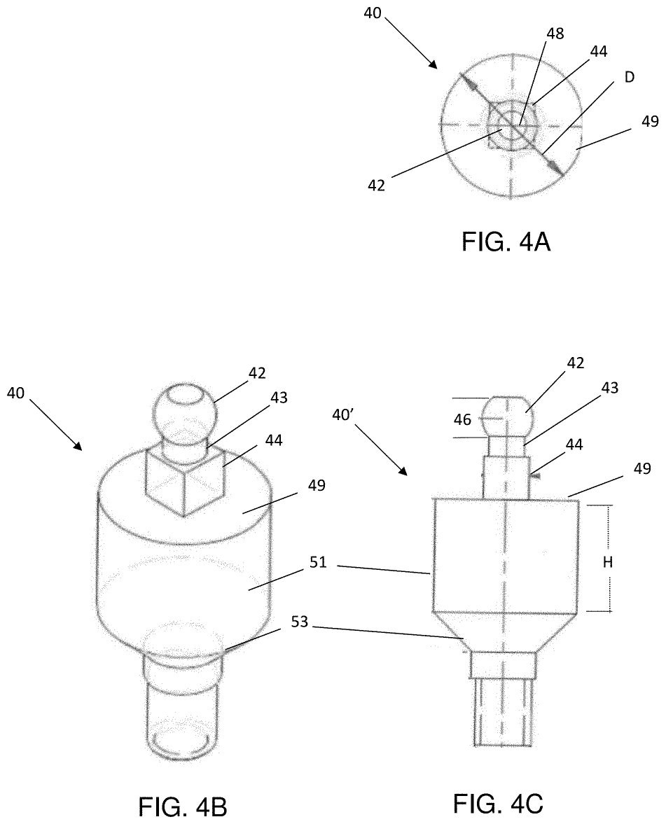

The process includes placing a sleeve 20 with a first inner diameter portion 21 and a second inner diameter portion 22, as shown in FIGS. 2A-2C over the O-ball joint portion 40 of an abutment 40 per FIGS. 4A-4C, or a conventional abutment. This is a great aid when subtraction from a prosthesis surface is required. While the sleeve 20 is depicted as cylindrical (being circular in cross section), it is appreciated that one or more portion thereof may have a polygonal cross-section without departing from the spirit of the invention. These polygonal shapes include triangular, square, pentagonal, and hexagonal. The O-ball joint portion 42 having an O-ball diameter that is larger than that of a neck portion 43 from which the O-ball portion extends. The sleeve 20 is formed from oral cavity compatible polymers and is sized such that the distal hemisphere extends into the inner diameter portion 21, while an intermediate portion 23 is sized to encompass the proximal hemisphere of an O-ball joint 40 and the between 10 and 80% of the neck portion 43 with the remainder of the neck and the joining surface 44 being encompassed within the second inner diameter portion 22. The intermediate portion 23 is sized to receive an O-ring between the O-ball portion 40 around the neck 41 and the inner wall of the sleeve 20. The sleeve 20 is readily formed in a variety of an oral cavity compatible polymers illustratively including polyurethane, polyamide, polyethylene, polypropylene, polymethylmethacrylate resin, polytetrafluoroethylene, and polyurethane. In some inventive embodiments, the polymer is ultra high molecular weight of from 1 to 10 million Daltons.

In some inventive embodiments, interior volume of the sleeve 20 and surrounding abutment 14 or 14′ is filled as mold cavity with a curable resin that is tissue compatible in a cured state. The conventional abutment 14 or an inventive abutment 40 forming a dam to inhibit resin leakage from the region surrounding the lower hemisphere of the O-ball joint portion 42, the neck 43 and the joining surface 44. Regardless of the whether a sleeve 20 surrounding an abutment includes an O-ring, a cured resin, or a combination thereof, the present invention limits motion of a conventional metal-O-ring retainer and socket retainer for a dental prosthesis or even precludes metal to metal contact with the first inner diameter portion 21 of the sleeve 20 retaining both the upper hemisphere of the ball joint portion 42 and the complementary prothesis socket without metal-housing contact. It has been surprisingly found that inclusion of the sleeve 20 extends operational lifetime of a prosthesis. Still more surprising, a patient is often able to exchange a worn sleeve and new sleeve without professional assistance.

It is also noted that in embodiments of the invention, existing available metal O-ring housings may be utilized in a subsurface position due to the design of the SSA abutment.

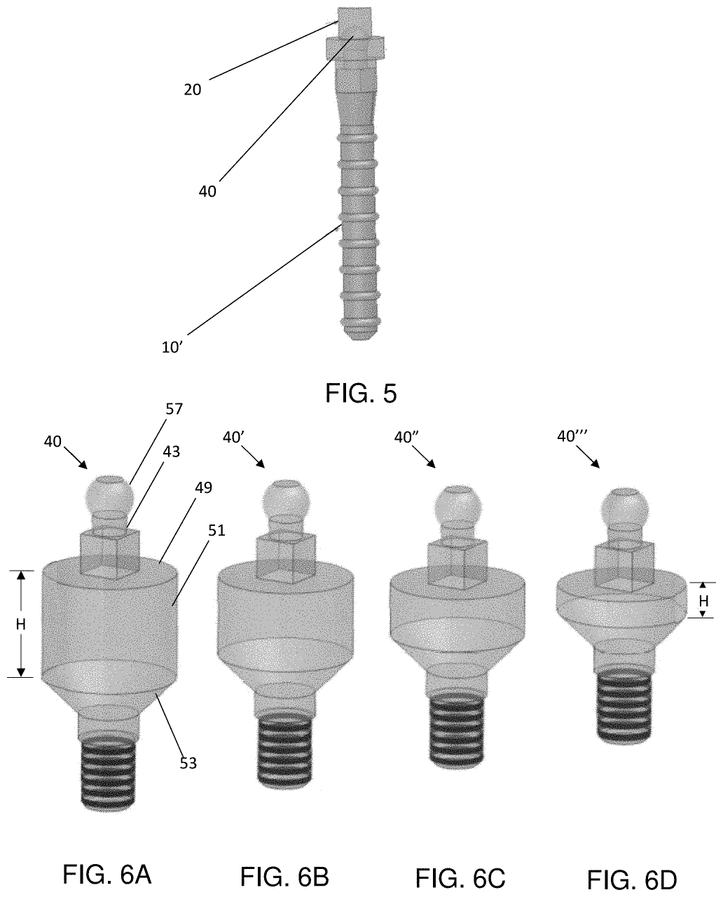

A complete inventive assembly inclusive of a sleeve 20 on an abutment 40 is mounted to an implant 10′ is shown in partial transparency in FIG. 5 in which the socket of prothesis, an O-ring, and cured resin are not shown for visual clarity.

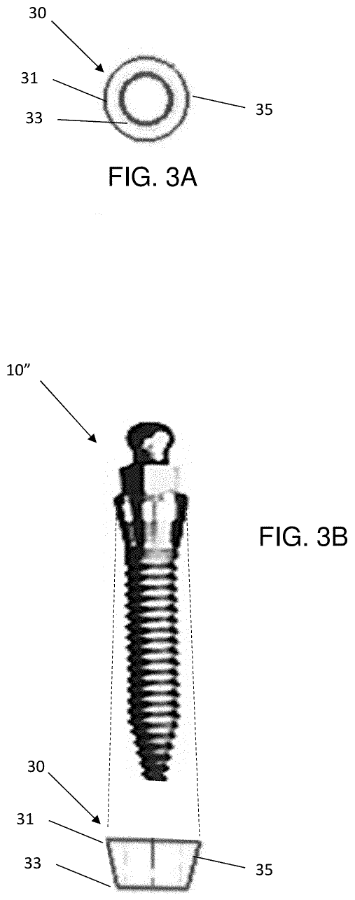

In some inventive embodiments, a spacer 30 is provided that is adapted to engage a conventional mini-implant 10″ to promote overlying reception of a sleeve 20 thereon. The spacer 30 is shown in a top view in FIG. 3A and a side exploded view with a conventional mini-implant 10″ for context in FIG. 3B. The spacer 30 has a truncated conical shape with a larger internal diameter at a first spacer end 31 relative to second spacer end 33. the spacer 30 increase an effective platform diameter of the implant 10″ as will be detailed further as to advantages with respect to FIGS. 4A-4C. In some inventive embodiments, the spacer 30 has external ridges or threads 35 to facilitate engagement with a sleeve 20. A spacer 30 is formed from materials such as those from which sleeve 20 are formed. In still other inventive embodiments, the sleeve 20 is formed as a unitary piece, independent of seams or joinders.

Embodiments of the inventive assembly utilize existing O-ball joint portion attachments available from different manufacturers, and although slightly different, interchangeable on all ball joint portion existing abutments on mini or small diameter implants. Embodiments of the inventive assembly provide a unique and novel abutment that combines an existing O-ball joint portion attachment apparatus with a variety of conventional implants and prosthesis. By way of example, by inverting a sleeve 20 with such that an inner diameter portion 21 is adapted to overlie a neck portion 43 a joining surface 44, a portion 23 extends from the O-ball portion 40 and accommodates a larger relative diameter prosthesis socket without the complications associated with a conventional metal-metal O-ball joint joinder between an abutment and a prosthesis.

An inventive abutment is shown generally at 40 in FIGS. 4A-4C having a distal O-ball 42 supported on a neck 43. In dentistry the distal O-ball 42 has a surface which is called occluded or incisal in position. In some inventive embodiments, the height of the neck 43 is reduced to 20 to 60% of the vertical extent 46 to the O-ball 42. A reduced vertical extent appears to extend the operational lifetime of the prothesis through decreasing wear. A tool joining surface 44 is provided in some inventive embodiments that is narrower than the diameter 48 of distal O-ball 40. In still other embodiments, the tool joining surface 44 has a vertical extent that is 90 to 130% of the vertical extent 46 to the O-ball 42. The inventive abutment 40 is characterized by a platform 49 has a diameter, D that is considerably larger than that of the prior art at between 4 and 6 mm. A base 51 has a height H of between 0.1 and 7 mm before joining a tapered section 53. It has been surprisingly found that a large diameter platform 49 provides an extended operational lifetime relative to prior art implants that typically have a diameter of 2 mm. It has been found that an inventive platform diameter affords a secondary structural support surface for a prothesis to transfer forces to the implant and thereby relieve forces on the O-ball 42. As a result, a lower profile prosthesis is readily developed that has less of the rocking forces exerted on a conventional prosthesis.

FIGS. 6A-6D depict a series of inventive abutments at 40, 40′, 40″, and 40′″; respectively. These inventive abutments at 40, 40′, 40″, and 40′″ vary only in the relative height, H of the platforms. FIG. 6A is a different perspective view of the inventive abutment depicted in FIGS. 4A-4C, where all the reference numerals have the aforementioned meanings ascribed thereto. FIGS. 6B-6D have the same features denoted in FIG. 6A with the proviso that each feature is primed, double primed, or triple primed, respectively; and are omitted for visual clarity.

An inventive abutment such as 40-40′″ are typically placed subsurface in the soft tissue and can also be placed subcrestal to the bone, which increases the sub tissue depth. When the attachment is to a sub tissue surface, a modification in diameter must be made to form a channel in the tissue large enough to allow clearance for the retentive element of a prosthesis. It is appreciated that an inventive device is provided as a detachable abutment or is provided as a unitary implant or mini-implant. A joining surface 44 extends from the platform 49 and a neck portion 43 extends therefrom that in turn is joined to an O-ball joint portion 42.

An inventive device 40-40′, compared to a conventional abutment, affords mating to the larger diameter conventional implant and proper contour in contacting the adjacent soft tissue to promote health and stability of the adjacent soft tissue. Also, an inventive device 40-40′″ has creates large enough channel in the soft tissue to allow for sub soft tissue surface attachment position, even in off parallel angle applications. An inventive device 40-40′″ is superior to conventional mini implants with a 60 to 150% reduction in height of surface position relative to soft tissue surface. The subsurface position of the inventive device 40-40′″ reduces rocking and lateral wear forces on the anchoring implant to stabilize the prosthesis being attached.

As a person skilled in the art will recognize from the previous detailed description and from the figures and claims, modifications and changes can be made to the preferred embodiments of the invention without departing from the scope of this invention defined in the following claims.

1. A dental prothesis subsurface assembly comprising:
an O-ball joint portion having a diameter, the O-ball joint portion distal from a neck portion, the neck portion having a smaller diameter than the O-ball portion and extending from an implant or an abutment;
a polymeric sleeve having a first inner diameter portion having a first inner diameter and a second inner diameter portion having a second inner diameter, the second inner diameter being a different than the first inner diameter; the second inner diameter portion or the first inner diameter portion adapted to overlie the neck portion and the O-ball joint portion and having a portion of the O-ball joint portion extending into the other portion, the other portion adapted to receive a socket of a prothesis to prevent direct contact between the O-ball joint portion and the socket.

2. The assembly of claim 1 wherein said polymeric sleeve further comprises an intermediate portion having an intermediation portion diameter that is larger than both the first inner diameter and the second inner diameter.

3. The assembly of claim 2 further comprising an O-ring within the intermediate portion and forming a seal between said polymeric sleeve and the O-ball joint portion or the neck portion.

4. The assembly of claim 1 further comprising a cured resin surrounding the neck portion and the O-ball joint portion.

5. The assembly of claim 1 wherein the second inner diameter is larger than the first inner diameter and the second inner diameter portion and alone or in combination with the intermediate region is adapted to overlie the neck region and a lower hemisphere of the O-ball joint portion.

6. The assembly of claim 1 wherein the O-ball joint portion and the socket are encased in cured resin.

7. The assembly of claim 1 wherein the O-ball joint portion and the neck portion are integral to said implant.

8. The assembly of claim 1 wherein the O-ball joint portion and the neck portion are integral to said abutment.

9. The assembly of claim 1 further comprising a proximal attachment portion interconnected to the neck portion.

10. A kit comprising:
a plurality of a mini-implants, abutments, or a combination thereof, each having an O-ball joint portion distal from a neck portion, the neck portion extending from an attachment portion that is joined to a platform having a larger diameter than the neck portion, the platform terminating in a base having a height, each of said plurality of the mini-implants, the abutments, or the combination thereof varying in the height; and
at least one polymeric sleeve having a first inner diameter portion having a first inner diameter and a second inner diameter portion having a second inner diameter, the second inner diameter being a different than the first inner diameter; the second inner diameter portion or the first inner diameter portion adapted to overlie the neck portion and the O-ball joint portion and having a portion of the O-ball joint portion extending into the other portion, the other portion adapted to receive a socket of a prothesis to prevent contact between the O-ball joint portion and the socket.

11. The kit of claim 10 wherein each of said plurality of the mini-implants, the abutments, or the combination thereof has a taper proximal to the attachment portion.

12. The kit of claim 10 wherein the diameter is between 4 and 6 mm.

13. The kit of claim 10 further comprising a collar to increase the diameter.

14. A process of joining a prosthesis to an implant comprising:
securing the implant to tissue of a patient, the implant terminating in an O-ball joint portion distal extending from a neck portion;
placing a polymeric sleeve over the O-ball joint portion and the neck portion; and
inserting a socket of the prosthesis over said polymeric sleeve to join the prosthesis and the implant without direct contact therebetween after an O-ring is installed in the resulting cavity.

15. The process of claim 14 further comprising filling said polymeric sleeve with a cured resin to encase the O-ball joint portion and the neck portion, the cured resin in simultaneous contact with the socket.

16. The process of claim 15 further comprising removing said sleeve.

17. An abutment comprising:
an O-ball joint portion distal from a neck portion, the neck portion extending from an attachment portion having a larger diameter than the neck portion,
the attachment portion extending from a platform having a diameter of from 4 to 6 mm and a base having a height,
a taper portion joined to the base.

18. The abutment of claim 17 wherein the diameter is 5 mm.

19. The abutment of claim 17 having a height of from 0.1 to 7 mm.

20. The abutment of claim 17 wherein the taper is integral with an implant.
